(19) United States
(12) Patent Application Publication
(10) Pub. No.: US 2026/0062020 A1
(43) Pub. Date: Mar. 5, 2026

(54) METHOD AND SYSTEM FOR CONTROLLING VEHICLE ACCORDING TO DRIVER'S LANE DEPARTURE INTENTION

(71) Applicant: HL KLEMOVE CORPORATION, Incheon (KR)

(72) Inventor: Haejun KIM, Pyeongtaek-si (KR)

(21) Appl. No.: 18/941,679

(22) Filed: Nov. 8, 2024

(30) Foreign Application Priority Data
Aug. 27, 2024 (KR) 10-2024-0114711

(51) Int. Cl. B60W 50/12; B60W 30/12; B60W 50/10; B60W 50/14

(52) U.S. Cl. CPC B60W 50/12; B60W 30/12; B60W 50/10; B60W 50/14; B60W 2510/202; B60W 2520/12; B60W 2540/106; B60W 2540/18

(57) ABSTRACT

A method and system for controlling a vehicle according to a driver's lane departure intention are provided, and the method for controlling the vehicle according to an embodiment of the present disclosure comprises: detecting an operation amount of an accelerator pedal of an ego vehicle; determining whether the operation amount of the accelerator pedal exceeds a selected first threshold value; measuring time from when the operation amount of the accelerator pedal exceeds the selected first threshold value; determining whether at least one selected condition is satisfied before a selected time elapses from the timing of measuring the time; determining that the driver's lane departure intention exists if the at least one selected condition is satisfied; and suppressing an operation of a driver assistance function.

### CROSS-REFERENCE TO RELATED APPLICATION

This application claims the benefit of and priority to Korean Patent Application No. 10-2024-0114711 filed on Aug. 27, 2024, the entire disclosures of which are incorporated herein by reference.

### TECHNICAL FIELD

The present disclosure relates to a method and system for controlling a vehicle according to a driver's lane departure intention. More specifically, the present disclosure relates to a method and system for controlling vehicle according to the driver's lane departure intention to suppress the operation of the lane departure warning function or the lane maintenance assistance function for driver assistance by detecting the driver's lane departure intention.

### BACKGROUND

In a vehicle, a driver assistance system provides assistance to the driver while driving in the vehicle for the driver's convenience.

For example, Lane Departure Warning (LDW) refers to a system that generates a haptic or sound warning when the ego vehicle departs its lane, and Lane Keeping Assist (LKA) refers to a system in which a steering system (e.g., Electronic Power Steering; EPS) intervenes to prevent the lane departure when the ego vehicle departs from the reference line of the driving lane.

Basically, the LDW or LKA system is activated when the turn signal is OFF and the driver leaves the lane. However, depending on the driver's tendency, lane changes often occur without the turn signal being turned on, and in these situations, the LDW/LKA system is operated according to the LDW/LKA system specifications.

In this case, a lane departure warning or a lane departure prevention control is performed despite the driver's lane departure intention, causing inconvenience to the driver and adversely affecting the driving stability.

Therefore, there is a need for the method and system for controlling the that can improve driver convenience and driving stability by identifying the driver's lane departure intention and by suppressing the operation of the driver assistance system.

### BRIEF SUMMARY

The present disclosure is to solve the above-mentioned problems of the prior art, and the object of the present disclosure is to provide a method and system for controlling the vehicle according to the driver's lane departure intention that can suppress the operation of the lane departure warning function or the lane keeping assist function by determining the driver's lane departure intention from the vehicle's behavior.

Further, the object of the present disclosure is to provide a method and system for controlling the vehicle that can effectively determine the driver's lane departure intention by determining that there is a lane departure intention if at least one selected (or in some embodiments, predetermined) condition is satisfied, in consideration of the specific conditions in case that the driver intentionally departs (leaves) the lane.

However, the technical problem to be achieved by the embodiments of the present disclosure is not limited to the technical problems described above, and other technical problems may exist.

As a technical means for achieving the above technical problem, a method for controlling a vehicle according to a driver's lane departure intention according to a first embodiment of the present disclosure comprises: detecting an operation amount of an accelerator pedal of an ego vehicle; determining whether the operation amount of the accelerator pedal exceeds a selected (or in some embodiments, predetermined) first threshold value; measuring time from when the operation amount of the accelerator pedal exceeds the selected (or in some embodiments, predetermined) first threshold value; determining whether at least one selected (or in some embodiments, predetermined) condition is satisfied before a selected (or in some embodiments, predetermined) time elapses from the timing of measuring the time; determining that the driver's lane departure intention exists if the at least one selected (or in some embodiments, predetermined) condition is satisfied; and suppressing an operation of a driver assistance function.

Further, the driver assistance function may be a lane departure warning function or a lane keeping assist function.

Further, the determining of whether the at least one selected (or in some embodiments, predetermined) condition is satisfied may comprise: determining whether a steering angle speed of the ego vehicle exceeds a selected (or in some embodiments, predetermined) threshold value for the steering angle speed; determining whether a steering torque of the ego vehicle exceeds a selected (or in some embodiments, predetermined) threshold value for the steering torque; and determining whether a lateral speed of the ego vehicle exceeds a selected (or in some embodiments, predetermined) threshold value for the lateral speed.

Further, in the determining that the driver's lane departure intention exists, if the steering angle speed of the ego vehicle exceeds the selected (or in some embodiments, predetermined) threshold value for the steering angle speed, the steering torque of the ego vehicle exceeds the selected (or in some embodiments, predetermined) threshold value for the steering torque, and the lateral speed of the ego vehicle exceeds the selected (or in some embodiments, predetermined) threshold value for the lateral speed, it may be determined that the driver's lane departure intention exists.

Further, the determining of whether the at least one selected (or in some embodiments, predetermined) condition is satisfied may further comprise determining whether a turn signal is on in a direction in which the ego vehicle departs a driving lane, and the determining that that the driver's lane departure intention exists may comprise determining that the driver has an intention to depart the driving lane if it is further satisfied that the turn signal is not turned on in the direction in which the ego vehicle departs the driving lane.

Further, the selected (or in some embodiments, predetermined) time may be 2 seconds.

A method for controlling a vehicle according to a driver's lane departure intention according to a second embodiment of the present disclosure comprises: detecting an operation amount of a brake pedal of an ego vehicle; determining whether the operation amount of the brake pedal exceeds a selected (or in some embodiments, predetermined) second threshold value; measuring time from when the operation amount of the brake pedal exceeds the selected (or in some embodiments, predetermined) second threshold value; determining whether at least one selected (or in some embodiments, predetermined) condition is satisfied before a selected (or in some embodiments, predetermined) time elapses from the timing of measuring the time; determining that the driver's lane departure intention exists if the at least one selected (or in some embodiments, predetermined) condition is satisfied; and suppressing an operation of a driver assistance function.

Further, the driver assistance function may be a lane departure warning function or a lane keeping assist function.

Further, the determining of whether the at least one selected (or in some embodiments, predetermined) condition is satisfied may comprise: determining whether a steering angle speed of the ego vehicle exceeds a selected (or in some embodiments, predetermined) threshold value for the steering angle speed; determining whether a steering torque of the ego vehicle exceeds a selected (or in some embodiments, predetermined) threshold value for the steering torque; and determining whether a lateral speed of the ego vehicle exceeds a selected (or in some embodiments, predetermined) threshold value for the lateral speed.

Further, in the determining that the driver's lane departure intention exists, if the steering angle speed of the ego vehicle exceeds the selected (or in some embodiments, predetermined) threshold value for the steering angle speed, the steering torque of the ego vehicle exceeds the selected (or in some embodiments, predetermined) threshold value for the steering torque, and the lateral speed of the ego vehicle exceeds the selected (or in some embodiments, predetermined) threshold value for the lateral speed, it may be determined that the driver's lane departure intention exists.

Further, the determining of whether the at least one selected (or in some embodiments, predetermined) condition is satisfied may further comprise determining whether a turn signal is on in a direction in which the ego vehicle departs a driving lane, and the determining that that the driver's lane departure intention exists may comprise determining that the driver has an intention to depart the driving lane if it is further satisfied that the turn signal is not turned on in the direction in which the ego vehicle departs the driving lane.

Further, the selected (or in some embodiments, predetermined) time may be 2 seconds.

A system for controlling a vehicle according to a driver's lane departure intention according to embodiments of the present disclosure comprises: a sensor configured to detect surroundings of an ego vehicle and detect body information of the ego vehicle; and a controller configured to determine the driver's lane departure intention and control an operation of a driver assistance function, wherein the sensor comprises an accelerator pedal sensor configured to detect an operation amount of an accelerator pedal and a brake pedal sensor configured to detect an operation amount of a brake pedal, and wherein if the operation amount of the accelerator pedal detected by the accelerator pedal sensor exceeds the selected (or in some embodiments, predetermined) first threshold value or the operation amount of the brake pedal detected by the brake pedal sensor exceeds the selected (or in some embodiments, predetermined) second threshold value, the controller is configured to measure time from when exceeding the selected (or in some embodiments, predetermined) first or second threshold value, and if at least one selected (or in some embodiments, predetermined) condition is satisfied before a selected (or in some embodiments, predetermined) time has elapsed from the timing of measuring the time, the controller is configured to determine that there exists the driver's lane departure intention and to suppress the operation of the driver assistance function.

Further, the driver assistance function may be a lane departure warning function or a lane keeping assistance function.

Further, the selected (or in some embodiments, predetermined) first threshold value and the selected (or in some embodiments, predetermined) second threshold value may be set to be equal.

The system may further comprise: a braking apparatus configured to control the longitudinal driving of the ego vehicle; a steering apparatus configured to control the lateral driving of the ego vehicle; and a warning apparatus configured to notify the driver of the ego vehicle of departure from a driving lane.

Further, the controller may be configured to suppress operation of at least one of the braking apparatus, the steering apparatus, or the warning apparatus by the lane departure warning function or the lane keeping assist function.

Further, the sensor may comprise a steering angle sensor, a steering torque sensor, and a vehicle speed sensor.

Further, before a selected (or in some embodiments, predetermined) time elapses from the timing of measuring the time, if the steering angle speed of the ego vehicle detected by the steering angle sensor exceeds a selected (or in some embodiments, predetermined) threshold value for the steering angle speed, the steering torque of the ego vehicle detected by the steering torque sensor exceeds a selected (or in some embodiments, predetermined) threshold value for the steering torque, and the lateral speed of the ego vehicle detected by the vehicle speed sensor exceeds a selected (or in some embodiments, predetermined) threshold value for the lateral speed, the controller may be configured to determine that the driver's lane departure intention exists.

Further, the sensor may further comprise a turn signal sensor configured to detect whether a turn signal light of the ego vehicle is turned on, and the turn signal sensor may be configured to detect whether the turn signal light is on in a direction that the ego vehicle departs the lane.

The above-described means for solving the problem is only exemplary and should not be construed as limiting the present disclosure. In addition to the exemplary embodiments described above, additional embodiments may exist in the drawings and the following detailed description.

According to the above-described problem-solving means of the present disclosure, it is possible to provide a method and system for controlling the vehicle according to the driver's lane departure intention that can improve the driver's driving convenience by suppressing the operation of the driver assistance function for warning or limiting the lane departure in case that the driver has the intention to depart the lane.

However, the effects obtainable from the present disclosure are not limited to the effects described above, and other effects may exist.

### BRIEF DESCRIPTION OF THE SEVERAL VIEWS OF THE DRAWINGS

FIG. 1 is a control flowchart showing a method for controlling a vehicle according to a driver's lane departure intention according to a first embodiment of the present disclosure.

FIG. 2 is a diagram illustrating in detail the step of determining whether at least one selected (or in some embodiments, predetermined) condition is satisfied before a selected (or in some embodiments, predetermined) time elapses in the method for controlling the vehicle according to the driver's lane departure intention according to the first embodiment of the present disclosure.

FIG. 3 is a control flowchart showing a method for controlling the vehicle according to the driver's lane departure intention according to a second embodiment of the present disclosure.

FIG. 4 is a diagram illustrating in detail the step of determining whether at least one selected (or in some embodiments, predetermined) condition is satisfied before a selected (or in some embodiments, predetermined) time elapses in the method for controlling the vehicle according to the driver's lane departure intention according to the second embodiment of the present disclosure.

FIG. 5 is a diagram for illustratively explaining the method for controlling the vehicle according to the driver's lane departure intention according to the first embodiment of the present disclosure.

FIG. 6 is a diagram for illustratively explaining the method for controlling the vehicle according to the driver's lane departure intention according to the second embodiment of the present disclosure.

FIG. 7 is a control configuration diagram schematically showing the configuration of a system for controlling the vehicle according to the driver's lane departure intention according to embodiments of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases where they are “indirectly connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part “includes” a certain component, it does not mean excluding other components, and it does mean that it may further include other components, unless otherwise stated.

Various embodiments of the present disclosure generally relate to a method and system for controlling a vehicle according to a driver's lane departure intention, which improves the driver's driving convenience by determining the driver's lane departure intention based on the vehicle's behavior.

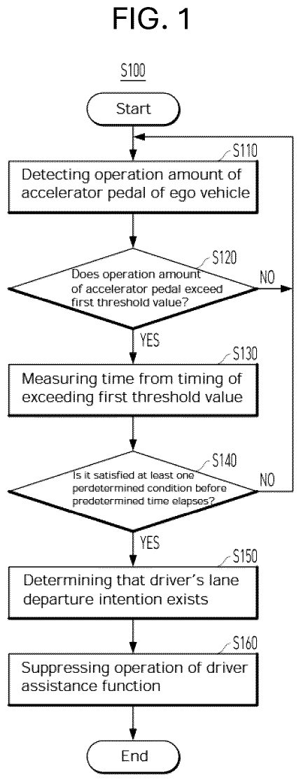

FIG. 1 is a control flowchart showing a method for controlling a vehicle according to a driver's lane departure intention according to a first embodiment of the present disclosure.

Referring to FIG. 1 of the present disclosure, the method for controlling the vehicle control method according to the driver's lane departure intention S100 according to the first embodiment of the present application may comprise detecting an operation amount of an accelerator pedal of an ego vehicle S110, and determining whether the operation amount of the accelerator pedal exceeds a selected (or in some embodiments, predetermined) first threshold value S120.

In general, in case that the driver of the ego vehicle wants to change lanes by departing the driving lane, in order to change lanes by avoiding other vehicles driving in the neighboring lane, the driver would step on the accelerator pedal of the ego vehicle and move in front side of the other vehicle and then rotate the steering wheel to move the ego vehicle into the empty space in the neighboring lane (Acceleration+Steering) (Case 1), or would press the brake pedal of the ego vehicle and move to the rear side of the other vehicle and then rotate the steering wheel to move to the ego vehicle into the empty space in the neighboring lane (Deceleration+Steering) (Case 2).

Therefore, according to the first embodiment of the present disclosure, in order to determine the driver's lane departure intention, the driver's operation amount of the accelerator pedal may be first detected, and whether the operation amount of the accelerator pedal exceeds a selected (or in some embodiments, predetermined) first threshold value may be determined (assuming Case 1). Here, the operation amount of the accelerator pedal may be calculated, for example, by the pressure with which the driver presses the accelerator pedal.

In the first embodiment of the present disclosure, if it is determined that the operation amount of the accelerator pedal exceeds the selected (or in some embodiments, predetermined) first threshold value (‘YES’ in S120), measuring time from when the operation amount of the accelerator pedal exceeds the selected (or in some embodiments, predetermined) first threshold value (S130) and determining whether at least one selected (or in some embodiments, predetermined) condition is satisfied before a selected (or in some embodiments, predetermined) time elapses from the timing of measuring the time (S140) may be performed. Meanwhile, if it is determined that the operation amount of the accelerator pedal does not exceed the selected (or in some embodiments, predetermined) first threshold value (‘NO’ in S120), the process may return to the accelerator pedal operation amount detection step (S110).

The reason for measuring the time from the timing when the operation amount of the accelerator pedal exceeds the selected (or in some embodiments, predetermined) first threshold value is to identify the driver's lane departure intention from the fact that the driver controls the vehicle in a selected (or in some embodiments, predetermined) manner within a selected (or in some embodiments, predetermined) time after pressing the accelerator pedal.

For example, after accelerating the vehicle, the driver needs to enter the neighboring lane within a selected (or in some embodiments, predetermined) time to reduce the risk of collision with another vehicle in the neighboring lane. That is, according to the first embodiment of the present disclosure, if a selected (or in some embodiments, predetermined) time has elapsed after the operation amount of the accelerator pedal exceeds a selected (or in some embodiments, predetermined) threshold value, it may be determined that the driver does not intend to leave the lane.

For example, in the embodiment of the present disclosure, the selected (or in some embodiments, predetermined) time may be approximately 2 seconds. In other words, if the driver performs a selected (or in some embodiments, predetermined) operation for departing the lane within approximately 2 seconds from the time that the operation amount of the accelerator pedal by the driver exceeds the selected (or in some embodiments, predetermined) first threshold value, it may be determined that the driver intends to leave the lane.

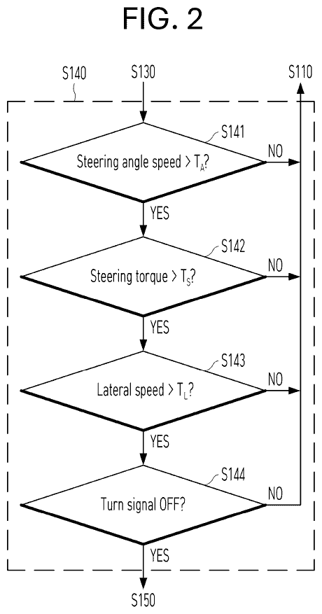

Meanwhile, a method of determining whether at least one selected (or in some embodiments, predetermined) condition is satisfied before a selected (or in some embodiments, predetermined) time elapses from the time measurement point will be explained in more detail in the description of FIG. 2.

If at least one selected (or in some embodiments, predetermined) condition is satisfied before a selected (or in some embodiments, predetermined) time has elapsed from the timing of measuring the time (‘YES’ in S140), determining that the driver's lane departure intention exists S150 may be performed. Meanwhile, if a selected (or in some embodiments, predetermined) time has elapsed from the timing of measuring the time, or if at least one selected (or in some embodiments, predetermined) condition is not satisfied, it may be assumed that there is no intention to change the lane, and the process may return to step S110.

After determining that there exists the driver's lane departure intention, suppressing the operation of the driver assistance function S160 may be performed. Here, the driver assistance function may be, more specifically, a lane departure warning (LDW) function or a lane keeping assist (LKA) function. That is, according to the embodiment of the present disclosure, the vehicle may be controlled so that LDW and LKA as driver assistance functions are not activated if the driver's lane departure intention exists.

The lane departure warning function may refer to a driver assistance function that detects the vehicle departing the lane and issues a warning to the driver. In addition, the lane keeping assist function may refer to a driver assistance function that detects the vehicle departing the lane and assists the vehicle to avoid departing the lane through a steering control by the system.

This driver assistance function is a function to assist the vehicle in driving along the driving lane. If the vehicle attempts to change lanes according to the driver's intention, a warning or steering control by the system may interrupt the driving. Therefore, according to the embodiment of the present disclosure, it is determined whether the driver's lane departure intention exists, and if the driver's lane departure intention exists, the vehicle may be controlled to suppress the operation of the warning by the lane departure warning function or suppress the operation of the steering control by the lane keeping assist function. Accordingly, it is possible to improve driving stability without the driver being interrupted when changing lanes.

FIG. 2 is a diagram illustrating in detail the step of determining whether at least one selected (or in some embodiments, predetermined) condition is satisfied before a selected (or in some embodiments, predetermined) time elapses in the method for controlling the vehicle according to the driver's lane departure intention according to the first embodiment of the present disclosure.

Referring to FIG. 2, it may be determined whether the steering angle speed of the ego vehicle detected before a selected (or in some embodiments, predetermined) time elapses from the timing of measuring the time exceeds a selected (or in some embodiments, predetermined) threshold value T_{A} (S141).

Here, if the steering angle speed of the ego vehicle exceeds the selected (or in some embodiments, predetermined) threshold value T_{A} (‘YES’ in S141), it may be determined whether the steering torque of the ego vehicle detected before a selected (or in some embodiments, predetermined) time has elapsed from the timing of measuring the time exceeds a selected (or in some embodiments, predetermined) threshold value T_{S} (S142). Meanwhile, if the steering angle speed of the ego vehicle does not exceed the selected (or in some embodiments, predetermined) threshold value T_{A} (‘NO’ in S141), the process may return to the accelerator pedal operation amount detection step (S110).

In step S142, if the steering torque of the ego vehicle exceeds the selected (or in some embodiments, predetermined) threshold value T_{S} (‘YES’ in S142), it may be determined whether the lateral speed of the ego vehicle exceeds a selected (or in some embodiments, predetermined) threshold value T_{L} (S143). Meanwhile, if the steering torque of the ego vehicle does not exceed the selected (or in some embodiments, predetermined) threshold value T_{S} (‘NO’ in S142), the process may return to the accelerator pedal operation amount detection step (S110).

In step S143, if the lateral speed of the ego vehicle exceeds the selected (or in some embodiments, predetermined) threshold value T_{L} (‘YES’ in S143), it may be determined whether a turn signal is turned on in the direction in which the ego vehicle departs the lane (S144). Meanwhile, if the lateral speed of the ego vehicle does not exceed the selected (or in some embodiments, predetermined) threshold value T_{L} (‘NO’ in S143), the process may return to the accelerator pedal operation amount detection step (S110).

In step S144, if the turn signal is not turned on in the direction in which the ego vehicle departs the lane (Turn signal OFF) (‘YES’ in S144), it may be determined that the driver's lane departure intention exists (S150). Meanwhile, if the turn signal is turned on in the direction in which the ego vehicle leaves the lane (Turn signal ON) (‘NO’ in S144), the process can return to the accelerator pedal operation amount detection step (S110).

As discussed above, if the operation amount of the accelerator pedal of the ego vehicle exceeds the first threshold value, the driver's lane departure intention may be determined through the steering angle speed, steering torque, and lateral speed of the ego vehicle within the selected (or in some embodiments, predetermined) time from the timing of measuring the time. Accordingly, it is possible to improve the driver's driving convenience by suppressing the operation of the driver assistance function.

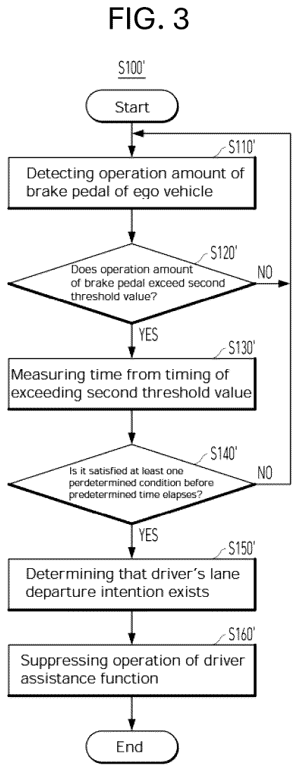

FIG. 3 is a control flowchart showing a method for controlling the vehicle according to the driver's lane departure intention according to a second embodiment of the present disclosure.

The second embodiment of the present disclosure may illustrate the method for controlling the vehicle according to the driver's lane departure intention in the case that the driver presses the brake pedal of the ego vehicle and moves to the rear side of the other vehicle and then rotate the steering wheel to move to the ego vehicle into the empty space in the neighboring lane (corresponding to Case 2 described above).

Referring to FIG. 3 of the present disclosure, the method for controlling the vehicle according to the driver's lane departure intention S100′ according to the second embodiment of the present disclosure may comprise detecting the operation amount of brake pedal of the ego vehicle S110′, and determining whether the operation amount of the brake pedal exceeds a selected (or in some embodiments, predetermined) second threshold value S120′.

Here, the operation amount of the brake pedal may be calculated, for example, by the pressure with which the driver presses the brake pedal, and the selected (or in some embodiments, predetermined) second threshold value regarding the brake pedal operation amount may be set to be equal to the selected (or in some embodiments, predetermined) first threshold value regarding the accelerator pedal operation amount in the first embodiment. However, the present disclosure is not limited thereto, and the first threshold value and the second threshold value may have different values, if necessary.

In the second embodiment of the present disclosure, if it is determined that the operation amount of the brake pedal exceeds the selected (or in some embodiments, predetermined) second threshold value (‘YES’ in S120′), measuring time from when the operation amount of the brake pedal exceeds the selected (or in some embodiments, predetermined) second threshold value S130′ and determining whether at least one selected (or in some embodiments, predetermined) condition is satisfied before a selected (or in some embodiments, predetermined) time elapses from the timing of measuring the time S140′ may be performed. Meanwhile, if it is determined that the operation amount of the brake pedal does not exceed the selected (or in some embodiments, predetermined) second threshold value (‘NO’ in S120′), the process may return to the brake pedal operation amount detection step (S110′).

The reason for measuring the time from the timing when the brake pedal operation amount exceeds the selected (or in some embodiments, predetermined) second threshold value is to identify the driver's lane departure intention from the fact that the driver controls the vehicle in a selected (or in some embodiments, predetermined) manner within a selected (or in some embodiments, predetermined) time after pressing the brake pedal.

For example, after slowing down the vehicle, the driver needs to enter the neighboring lane within a selected (or in some embodiments, predetermined) time to reduce the risk of collision with another vehicle in the neighboring lane. That is, according to the second embodiment of the present disclosure, if a selected (or in some embodiments, predetermined) time has elapsed after the operation amount of the brake pedal exceeds a selected (or in some embodiments, predetermined) threshold value, it may be determined that the driver does not intend to leave the lane.

For example, the selected (or in some embodiments, predetermined) time in the second embodiment of the present disclosure may be approximately 2 seconds as in the first embodiment of the present disclosure. In other words, if the driver performs a selected (or in some embodiments, predetermined) operation for departing the lane within approximately 2 seconds from the time that the operation amount of the brake pedal by the driver exceeds the selected (or in some embodiments, predetermined) second threshold value, it may be determined that the driver intends to leave the lane.

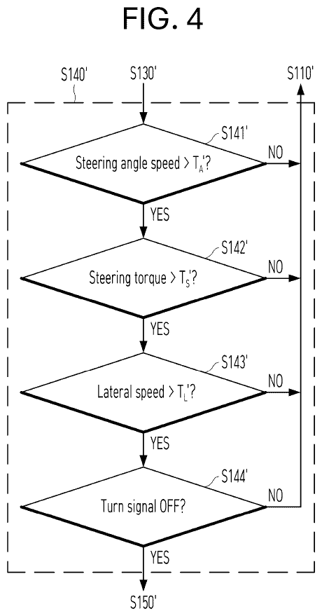

Meanwhile, a method of determining whether at least one selected (or in some embodiments, predetermined) condition is satisfied before a selected (or in some embodiments, predetermined) time elapses from the time measurement point will be explained in more detail in the description of FIG. 4.

If at least one selected (or in some embodiments, predetermined) condition is satisfied before a selected (or in some embodiments, predetermined) time has elapsed from the timing of measuring the time (‘YES’ in S140′), determining that the driver's lane departure intention exists S150′ may be performed. Meanwhile, if a selected (or in some embodiments, predetermined) time has elapsed from the timing of measuring the time, or if at least one selected (or in some embodiments, predetermined) condition is not satisfied, it may be assumed that there is no intention to change the lane, and the process may return to step S110′.

After determining that there exists the driver's lane departure intention, suppressing the operation of the driver assistance function S160′ may be performed. Here, the driver assistance function may be, more specifically, a lane departure warning (LDW) function or a lane keeping assist (LKA) function.

FIG. 4 is a diagram illustrating in detail the step of determining whether at least one selected (or in some embodiments, predetermined) condition is satisfied before a selected (or in some embodiments, predetermined) time elapses in the method for controlling the vehicle according to the driver's lane departure intention according to the second embodiment of the present disclosure.

Referring to FIG. 4, it may be determined whether the steering angle speed of the ego vehicle detected before a selected (or in some embodiments, predetermined) time elapses from the timing of measuring the time exceeds a selected (or in some embodiments, predetermined) threshold value T_{A}′ (S141′). The selected (or in some embodiments, predetermined) threshold value T_{A}′ in the second embodiment may be the same as the selected (or in some embodiments, predetermined) threshold value T_{A} in the first embodiment of the present disclosure.

Here, if the steering angle speed of the ego vehicle exceeds the selected (or in some embodiments, predetermined) threshold value T_{A}′ (‘YES’ in S141′), it may be determined whether the steering torque of the ego vehicle detected before a selected (or in some embodiments, predetermined) time has elapsed from the timing of measuring the time exceeds a selected (or in some embodiments, predetermined) threshold value T_{S}′ (S142′). The selected (or in some embodiments, predetermined) threshold value T_{S}′ in the second embodiment may be the same as the selected (or in some embodiments, predetermined) threshold value T_{S} in the first embodiment. Meanwhile, if the steering angle speed of the ego vehicle does not exceed the selected (or in some embodiments, predetermined) threshold value T_{A}′ (‘NO’ in S141′), the process may return to the brake pedal operation amount detection step (S110′).

In step S142′, if the steering torque of the ego vehicle exceeds the selected (or in some embodiments, predetermined) threshold value T_{S}′ (‘YES’ in S142′), it may be determined whether the lateral speed of the ego vehicle exceeds the selected (or in some embodiments, predetermined) threshold value T_{L}′ (S143′). Meanwhile, if the steering torque of the ego vehicle does not exceed the selected (or in some embodiments, predetermined) threshold value T_{S}′ (‘NO’ in S142′), the process may return to the brake pedal operation amount detection step (S110′).

In step S143′, if the lateral speed of the ego vehicle exceeds a selected (or in some embodiments, predetermined) threshold value T_{L}′ (‘YES’ in S143′), it may be determined whether a turn signal is turned on in the direction in which the ego vehicle departs the lane (S144′). Meanwhile, if the lateral speed of the ego vehicle does not exceed the selected (or in some embodiments, predetermined) threshold value T_{L}′ (‘NO’ in S143′), the process may return to the brake pedal operation amount detection step (S110′).

In step S144′, if the turn signal is not turned on in the direction in which the ego vehicle departs the lane (Turn signal OFF) (‘YES’ in S144′), it may be determined that the driver's lane departure intention exists (S150′). Meanwhile, if the turn signal is turned on in the direction in which the ego vehicle departs the lane (Turn signal ON) (‘NO’ in S144′), the process may return to the brake pedal operation amount detection step (S110′).

Meanwhile, the selected (or in some embodiments, predetermined) threshold values (T_{A}′, T_{S}′, T_{L}′) in the second embodiment may be set to be the same as the selected (or in some embodiments, predetermined) threshold values (T_{A}, T_{S}, T_{L}) in the first embodiment. However, the present disclosure is not limited thereto, and the values may be set differently as needed.

As discussed above, if the operation amount of the brake pedal of the ego vehicle exceeds the second threshold value, the driver's lane departure intention may be determined through the steering angle speed, steering torque, and lateral speed of the ego vehicle within the selected (or in some embodiments, predetermined) time from the timing of measuring the time. Accordingly, it is possible to improve the driver's driving convenience by suppressing the operation of the driver assistance function.

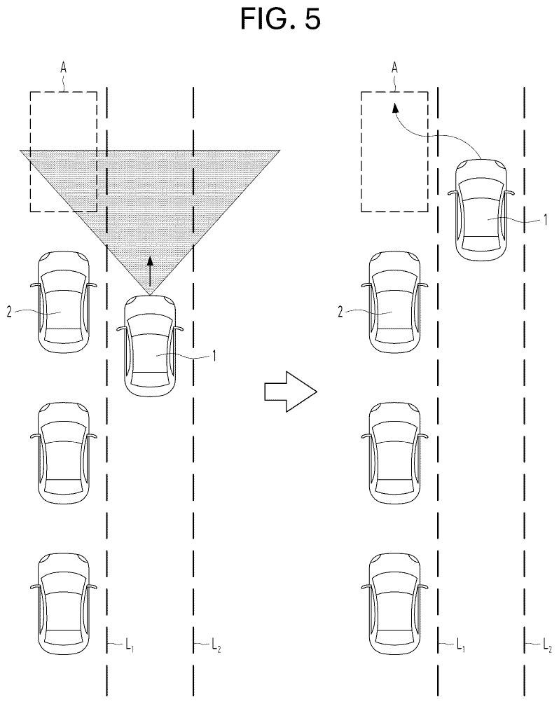

FIG. 5 is a diagram for illustratively explaining the method for controlling the vehicle according to the driver's lane departure intention according to the first embodiment of the present disclosure.

Referring to FIG. 5, while an ego vehicle 1 is driving in a driving lane having a left lane line L₁ and a right lane line L₂, the ego vehicle 1 may want to change lanes in the direction in which one of the two lane lines is located (for example, in the left lane line in FIG. 5). In this case, the ego vehicle 1 may use a sensor (for example, a front camera or a front radar) to recognize whether a cut-in area A to which the lane change can be performed exists in the neighboring lane on the front side.

Meanwhile, if there is a first peripheral vehicle 2 driving in the neighboring lane close to the ego vehicle 1, the driver of the ego vehicle 1 may accelerate the vehicle by operating the accelerator pedal. As shown in the right-side drawing of FIG. 5, after moving forward by acceleration of the ego vehicle 1, the driver of the ego vehicle may perform a steering operation to move the vehicle to the cut-in area A within a selected (or in some embodiments, predetermined) time. If this steering operation satisfies at least one selected (or in some embodiments, predetermined) condition, it may be determined that the driver's lane departure intention exists, and the lane departure warning function or the lane keeping assist function of the driver assistance system may be controlled to be suppressed.

The method for controlling the vehicle according to the driver's lane departure intention in the scenario shown in FIG. 5 has been explained in detail through the description of FIGS. 1 and 2, so detailed description will be omitted here.

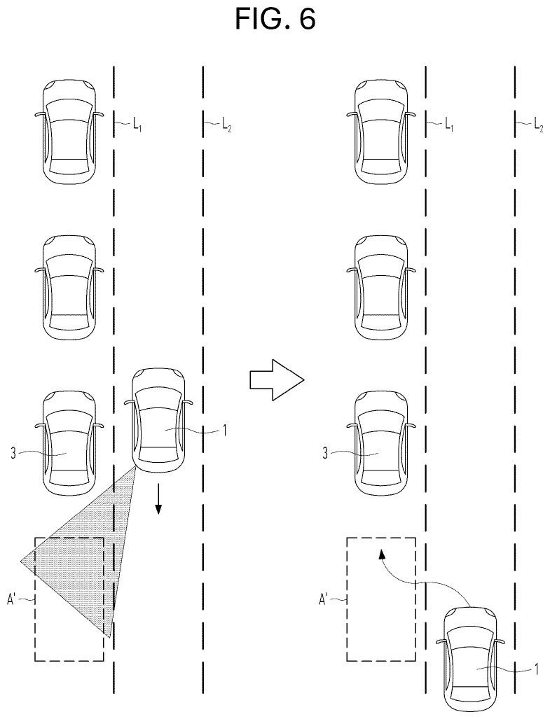

FIG. 6 is a diagram for illustratively explaining the method for controlling the vehicle according to the driver's lane departure intention according to the second embodiment of the present disclosure.

Referring to FIG. 6, while an ego vehicle 1 is driving in a driving lane having a left lane line L₁ and a right lane line L₂, the ego vehicle 1 may want to change lanes in the direction in which one of the two lane lines is located. In this case, the ego vehicle 1 may use a sensor (for example, a rear corner radar) to recognize whether a cut-in area A′ to which the lane change can be performed exists in the neighboring lane on the rear side.

Meanwhile, when there is a second peripheral vehicle 3 driving in the neighboring lane close to the ego vehicle 1, the driver of the ego vehicle 1 may slow down the vehicle by operating the brake pedal. As shown in the right-side drawing of FIG. 6, after moving rearward of the second peripheral vehicle 3 by deceleration of the ego vehicle 1, the driver of the ego vehicle may perform a steering operation to move the vehicle to the cut-in area A′ within a selected (or in some embodiments, predetermined) time. If this steering operation satisfies at least one selected (or in some embodiments, predetermined) condition, it may be determined that the driver's lane departure intention exists, and the lane departure warning function or the lane keeping assist function of the driver assistance system may be controlled to be suppressed.

The method for controlling the vehicle according to the driver's lane departure intention in the scenario shown in FIG. 6 has been explained in detail through the description of FIGS. 3 and 4, so detailed description will be omitted here.

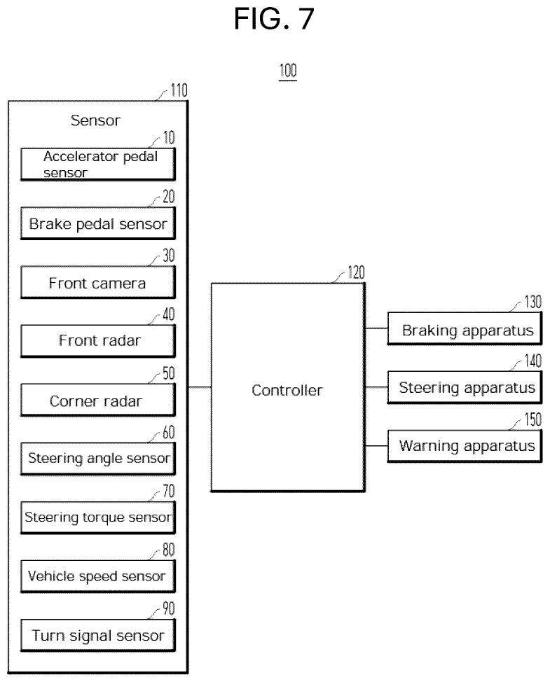

FIG. 7 is a control configuration diagram schematically showing the configuration of a system for controlling the vehicle according to the driver's lane departure intention according to embodiments of the present disclosure.

Referring to FIG. 7, the system for controlling the vehicle according to the driver's lane departure intention 100 according to embodiments of the present disclosure may comprise a sensor 110 configured to detects surroundings of the ego vehicle and detect body information of the ego vehicle, and a controller 120 configured to determine the driver's lane departure intention and control the operation of the driver assistance function.

Additionally, the sensor 110 may comprise an accelerator pedal sensor 10 configured to detect the operation amount of the accelerator pedal of the ego vehicle and a brake pedal sensor 20 configured to detect the operation amount of the brake pedal of the ego vehicle.

In addition, if the operation amount of the accelerator pedal detected by the accelerator pedal sensor 10 exceeds the selected (or in some embodiments, predetermined) first threshold value or the operation amount of the brake pedal detected by the brake pedal sensor 20 exceeds the selected (or in some embodiments, predetermined) second threshold value, the controller 120 may measure time from exceeding the first or second threshold value, and if at least one selected (or in some embodiments, predetermined) condition is satisfied before the selected (or in some embodiments, predetermined) time has elapsed from the time of measuring the time, the controller 120 may determine that there exists the driver's lane departure intention and control to suppress the operation of the driver assistance function.

The driver assistance function may be a lane departure warning function or a lane keeping assist function, and the selected (or in some embodiments, predetermined) first threshold value and the selected (or in some embodiments, predetermined) second threshold value may be set to be the same.

Further, the sensor 110 may comprise at least one of a front camera 30, a front radar 40, and at least one corner radar 50. However, the present disclosure is not limited thereto, and the sensor may further include other types of sensors for detecting the surroundings of the vehicle, such as ultrasonic sensors and lidar sensors. Using these sensors, it is possible to recognize whether there is a cut-in area in which lane change may be performed in the neighboring lane of the lane in which the ego vehicle is driving.

Meanwhile, the sensor 110 may further comprise at least one vehicle body information sensor for detecting body information of the ego vehicle. Specifically, the sensor 110 may include a steering angle sensor 60 configured to detect the steering angle speed of the ego vehicle, a steering torque sensor 70 configured to measure the steering torque of the ego vehicle, and a vehicle speed sensor 80 configured to detect the lateral speed of the ego vehicle.

Accordingly, the controller 120 may determine that there exists the driver's lane departure intention if the steering angle speed detected by the steering angle sensor 60 exceeds a selected (or in some embodiments, predetermined) threshold value, and the steering torque detected by the steering torque sensor 70 exceeds a selected (or in some embodiments, predetermined) threshold value and the lateral speed detected by the vehicle speed sensor 80 exceeds a selected (or in some embodiments, predetermined) threshold value, before a selected (or in some embodiments, predetermined) time has elapsed from the timing of measuring the time.

In addition, the sensor 110 may further comprise a turn signal sensor 90 configured to detect whether the turn signal light of the ego vehicle is turned on. The turn signal sensor 90 may detect whether the turn signal light is on in the lane departure direction of the ego vehicle, and the information from the turn signal sensor 90 may be used to determine the driver's lane departure intention.

In addition, the system for controlling the vehicle according to the driver's lane departure intention 100 according to the embodiments of the present disclosure may comprise a braking apparatus 130 configured to control the longitudinal driving of the ego vehicle, a steering apparatus 140 configured to control the lateral driving of the ego vehicle, and a warning apparatus 150 configured to notify the driver of the ego vehicle of departure from the driving lane.

For example, the warning apparatus 150 may include at least one of a visual alarm device, an audible alarm device, and a haptic alarm device, and thus, the warning apparatus 150 may notify the driver of the vehicle of departure from the driving lane by performing a visual alarm, an audible alarm, and/or a haptic alarm.

In addition, the controller 120 may control to suppress the operation of at least one of the braking apparatus 130, the steering apparatus 140, or the warning apparatus 150 caused by the lane departure warning function or the lane keeping assist function.

Since the specific method for controlling the vehicle according to the first and second embodiments of the present disclosure performed by the controller 120 has been described in detail previously, the detailed description will be omitted here.

According to the embodiments of the present disclosure as described above, it is possible to provide the method and system for controlling the vehicle according to the driver's lane departure intention that can improve the driver's driving convenience by suppressing the operation of the driver assistance function for warning or limiting the lane departure in case that the driver has the intention of departing the lane.

In addition, according to the embodiments of the present disclosure, it is possible to more effectively determine the driver's lane departure intention based on the operation amount of the accelerator pedal or the operation amount of the brake pedal, with the vehicle's behavior information.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

### EXPLANATION OF REFERENCE

1: Ego vehicle
2: First peripheral vehicle
3: Second peripheral vehicle
10: Accelerator pedal sensor
20: Brake pedal sensor
30: Front camera
40: Front radar
50: Corner radar
60: Steering angle sensor
70: Steering torque sensor
80: Vehicle speed sensor
90: Turn signal sensor
100: System for controlling vehicle according to driver's lane departure intention
110: Sensor
120: Controller
130: Braking apparatus
140: Steering apparatus
150: Warning apparatus
A, A′: Cut-in area

What is claimed is:

1. A method for controlling a vehicle according to a driver's lane departure intention, comprising:
detecting an operation amount of an accelerator pedal of an ego vehicle;
determining whether the operation amount of the accelerator pedal exceeds a selected first threshold value;
measuring time from when the operation amount of the accelerator pedal exceeds the selected first threshold value;
determining whether at least one selected condition is satisfied before a selected time elapses from the timing of measuring the time;
determining that the driver's lane departure intention exists if the at least one selected condition is satisfied; and
suppressing an operation of a driver assistance function.

2. The method of claim 1, wherein the driver assistance function is a lane departure warning function or a lane keeping assist function.

3. The method of claim 2, wherein the determining of whether the at least one selected condition is satisfied comprises: determining whether a steering angle speed of the ego vehicle exceeds a selected threshold value for the steering angle speed; determining whether a steering torque of the ego vehicle exceeds a selected threshold value for the steering torque; and determining whether a lateral speed of the ego vehicle exceeds a selected threshold value for the lateral speed.

4. The method of claim 3, wherein in the determining that the driver's lane departure intention exists, if the steering angle speed of the ego vehicle exceeds the selected threshold value for the steering angle speed, the steering torque of the ego vehicle exceeds the selected threshold value for the steering torque, and the lateral speed of the ego vehicle exceeds the selected threshold value for the lateral speed, it is determined that the driver's lane departure intention exists.

5. The method of claim 4, wherein the determining of whether the at least one selected condition is satisfied further comprises determining whether a turn signal is on in a direction in which the ego vehicle departs a driving lane, and
the determining that that the driver's lane departure intention exists comprises determining that the driver has an intention to depart the driving lane if it is further satisfied that the turn signal is not turned on in the direction in which the ego vehicle departs the driving lane.

6. The method of claim 1, wherein the selected time is 2 seconds.

7. A method for controlling a vehicle according to a driver's lane departure intention, comprising:
detecting an operation amount of a brake pedal of an ego vehicle;
determining whether the operation amount of the brake pedal exceeds a selected second threshold value;
measuring time from when the operation amount of the brake pedal exceeds the selected second threshold value;
determining whether at least one selected condition is satisfied before a selected time elapses from the timing of measuring the time;
determining that the driver's lane departure intention exists if the at least one selected condition is satisfied; and
suppressing an operation of a driver assistance function.

8. The method of claim 7, wherein the driver assistance function is a lane departure warning function or a lane keeping assist function.

9. The method of claim 8, wherein the determining of whether the at least one selected condition is satisfied comprises: determining whether a steering angle speed of the ego vehicle exceeds a selected threshold value for the steering angle speed; determining whether a steering torque of the ego vehicle exceeds a selected threshold value for the steering torque; and determining whether a lateral speed of the ego vehicle exceeds a selected threshold value for the lateral speed.

10. The method of claim 9, wherein in the determining that the driver's lane departure intention exists, if the steering angle speed of the ego vehicle exceeds the selected threshold value for the steering angle speed, the steering torque of the ego vehicle exceeds the selected threshold value for the steering torque, and the lateral speed of the ego vehicle exceeds the selected threshold value for the lateral speed, it is determined that the driver's lane departure intention exists.

11. The method of claim 10, wherein the determining of whether the at least one selected condition is satisfied further comprises determining whether a turn signal is on in a direction in which the ego vehicle departs a driving lane, and
the determining that that the driver's lane departure intention exists comprises determining that the driver has an intention to depart the driving lane if it is further satisfied that the turn signal is not turned on in the direction in which the ego vehicle departs the driving lane.

12. The method of claim 7, wherein the selected time is 2 seconds.

13. A system for controlling a vehicle according to a driver's lane departure intention, comprising:
a sensor configured to detect surroundings of an ego vehicle and detect body information of the ego vehicle; and
a controller configured to determine the driver's lane departure intention and control an operation of a driver assistance function,
wherein the sensor comprises an accelerator pedal sensor configured to detect an operation amount of an accelerator pedal and a brake pedal sensor configured to detect an operation amount of a brake pedal, and
wherein if the operation amount of the accelerator pedal detected by the accelerator pedal sensor exceeds the selected first threshold value or the operation amount of the brake pedal detected by the brake pedal sensor exceeds the selected second threshold value, the controller is configured to measure time from when exceeding the selected first or second threshold value, and if at least one selected condition is satisfied before a selected time has elapsed from the timing of measuring the time, the controller is configured to determine that there exists the driver's lane departure intention and to suppress the operation of the driver assistance function.

14. The system of claim 13, wherein the driver assistance function is a lane departure warning function or a lane keeping assistance function.

15. The system of claim 13, wherein the selected first threshold value and the selected second threshold value are set to be equal.

16. The system of claim 14, further comprising:
a braking apparatus configured to control a longitudinal driving of the ego vehicle;
a steering apparatus configured to control a lateral driving of the ego vehicle; and
a warning apparatus configured to notify the driver of the ego vehicle of departure from a driving lane.

17. The system of claim 16, wherein the controller is configured to suppress operation of at least one of the braking apparatus, the steering apparatus, or the warning apparatus by the lane departure warning function or the lane keeping assist function.

18. The system of claim 17, wherein the sensor comprises a steering angle sensor, a steering torque sensor, and a vehicle speed sensor.

19. The system of claim 18, wherein before a selected time elapses from the timing of measuring the time, if the steering angle speed of the ego vehicle detected by the steering angle sensor exceeds a selected threshold value for the steering angle speed, the steering torque of the ego vehicle detected by the steering torque sensor exceeds a selected threshold value for the steering torque, and the lateral speed of the ego vehicle detected by the vehicle speed sensor exceeds a selected threshold value for the lateral speed, the controller is configured to determine that the driver's lane departure intention exists.

20. The system of claim 19, wherein the sensor further comprises a turn signal sensor configured to detect whether a turn signal light of the ego vehicle is turned on, and
the turn signal sensor is configured to detect whether the turn signal light is on in a direction that the ego vehicle departs the lane.
